(19) United States
(12) Patent Application Publication
(10) Pub. No.: US 2006/0012861 A1
(43) Pub. Date: Jan. 19, 2006

(54) Ergotube and inverted microscope having an ergotube

(75) Inventors: Peter Euteneuer, Lahnau (DE); Ralf Kruger, Butzbach/Griedel (DE)

Correspondence Address: HOUSTON ELISEEVA, 4 MILITIA DRIVE, SUITE 4, LEXINGTON, MA, 02421, US

(73) Assignee: Leica Microsystems CMS GmbH, Wetzlar (DE)

(21) Appl. No.: 11/181,451

(22) Filed: Jul. 14, 2005

(30) Foreign Application Priority Data
Jul. 19, 2004 (DE) DE102004034846.4

(51) Int. Cl. G02B 21/00; G02B 21/20

(52) U.S. Cl. 359/384; 359/368

(57) ABSTRACT

An inverted microscope (1) equipped with an ergotube (9) is disclosed. The ergotube (9) substantially comprises an eyepiece (9a) and a tube housing (9b). The microscope beam path (30) defined by the inverted microscope (1) is of U-shaped configuration. The U-shaped microscope beam path (30) is deflected into the eyepiece (9a) by a single deflection element (74) that is embodied as a pivotable mirror.

### RELATED APPLICATIONS

This application claims priority of the German patent application 10 2004 034 846.4 which is incorporated by reference herein.

### FIELD OF THE INVENTION

The invention concerns an ergotube. The invention concerns in particular an ergotube which encompasses an eyepiece that defines an eyepiece beam path. The ergotube further encompasses a tube housing that defines a tube beam path. The ergotube is equipped with an installation element in order to mount the ergotube on a microscope stand. A mirror equipped with a mirror surface deflects the tube beam path into the eyepiece beam path, the eyepiece being embodied pivotably about an axis. Upon pivoting of the eyepiece through an angle α, the mirror pivots about an angle α/2.

### BACKGROUND OF THE INVENTION

The invention further concerns an inverted microscope having an ergotube. The invention concerns in particular an inverted microscope having an ergotube that comprises an eyepiece and a tube housing. The microscope encompasses at least one objective and two deflection elements that are arranged along a U-shaped microscope beam path. Also provided is a third deflection element that deflects the microscope beam path into the eyepiece.

Unpublished German Patent Application DE 10 2004 006 937.9 discloses a tube for a microscope. Here, upon a change equal to a value α in the inclination of the eyepiece beam path with respect to the horizontal, the deflection mirror is positioned differently in its arrangement by an amount equal to an angle α/2. The eyepiece and the deflection mirror are configured pivotably, their pivoting motion being constrainedly coupled. A pivoting of the eyepiece equal to a value α results in a pivoting of the deflection mirror equal to a value α/2. In addition to the deflection mirror, there is provided in the tube beam path a deflection element that deflects the microscope beam path so that the latter strikes the deflection mirror, which is arranged behind the microscope beam path as viewed from the user's location. The arrangement of the further deflection element in the tube results in an increase in overall depth, which is to be avoided by the present invention.

Published U.S. Patent Application 2004/0001253 discloses an inverted microscope having a V-shaped microscope beam path. In an inverted microscope, it is necessary for visual viewing with a binocular tube to implement an odd number of reflections in the microscope beam path, so that the laterally correct image position desired by the user is achieved. In the case of the V-shaped beam path disclosed here, this is achieved with one reflection. The V-shaped beam path in an inverted microscope has the disadvantage that the space for additional optical elements that are to be moved into the beam path in motorized or mechanical fashion is limited.

U.S. Pat. No. 6,404,564 discloses an inverted microscope having a U-shaped beam path. The U-shaped beam path is produced in the microscope by way of two appropriately arranged prisms, each of which causes a deflection through 90°. By way of a further reflection that produces a deflection through 45°, the microscope beam path or tube beam path is deflected into an eyepiece. An adjustment of the inclination of the eyepiece, and thus a variable viewing angle of the eyepiece, is not disclosed here.

German Unexamined Application DE 26 40 974 likewise discloses a light microscope of inverted design. Here as well, a U-shaped microscope beam path is disclosed, formed by two reflections through 90° in the interior of the microscope. A further reflection directs the microscope beam path into an eyepiece. A variable inclination of the eyepiece is not disclosed in this document.

### SUMMARY OF THE INVENTION

It is the object of the invention to create an ergotube which possesses a variable viewing angle, has a shallow overall depth, and minimizes the number of reflections for deflection of the microscope beam path into the eyepiece.

The stated object is achieved by an ergotube that comprises: an eyepiece that defines an eyepiece beam path, a tube housing that defines a tube beam path, a mirror having a mirror surface that deflects the tube beam path into the eyepiece beam path, an axis about which the eyepiece embodied pivotably; wherein the axis extends centeredly on the mirror surface and wherein upon pivoting of the eyepiece through an angle α, the mirror is pivoted about an angle α/2, and the mirror is the only deflection element in the tube housing.

A further object of the invention is to create an inverted microscope which makes available sufficient room for the installation or addition of further motorized microscope functions or motorized microscope components and is ergonomically operable by the user, and in which incoupling of the microscope beam path into the eyepiece of the ergotube requires a minimum number of reflections.

The aforesaid object is achieved by an inverted microscope having an ergotube made up of an eyepiece and a tube housing, having at least one objective, having a first deflection element and a second deflection element that are both arranged along a U-shaped microscope beam path, and having a single third deflection element that deflects the microscope beam path into the eyepiece, wherein the third deflection element is embodied as a mirror pivotable about an axis and the eyepiece of the ergotube is deflectable about the axis; and the axis sits in the center of the mirror surface defined by the pivotable mirror.

The invention has the advantage that in an ergotube which encompasses an eyepiece that defines an eyepiece beam path, incoupling of the tube beam path or microscope beam path into the eyepiece is accomplished with a minimum number of reflections. The ergotube is equipped, in addition to the eyepiece (which can be configured as a binocular eyepiece), with a tube housing into which the tube beam path or microscope beam path enters. The ergotube is further equipped with an installation element for mounting it on the microscope stand. Arranged in the tube housing is a mirror that has a mirror surface and deflects the tube beam path or microscope beam path into the eyepiece beam path. The eyepiece itself is embodied pivotably about an axis, and upon pivoting of the eyepiece through an angle α, the mirror is concurrently pivoted through an angle α/2. A cylindrical holding element for the mirror is provided on the axis. The mirror itself is the only deflection element arranged in the tube housing. The mirror itself is installed in the holding element in such a way that the axis extends centeredly on the mirror surface.

It is also advantageous to configure an inverted microscope with the ergonomic tube that comprises an eyepiece and a tube housing. The inverted microscope itself encompasses at least one objective and two deflection elements that are arranged along a U-shaped microscope beam path. Also provided is a third deflection element that deflects the microscope beam path into the eyepiece. The third deflection element is embodied as a pivotable mirror.

The eyepiece of the ergotube is pivotable about an axis that sits or extends in the center of the mirror surface defined by the mirror.

The eyepiece is pivotable with respect to the horizontal in an angular range of 10° to 40°.

The eyepiece and the mirror are constrainedly coupled, i.e. a pivoting motion of the eyepiece through an angle α causes the mirror to pivot through an angle α/2.

The microscope beam path is coupled into the eyepiece according to the Siedentopf principle.

In the interior of the tube, a roller is arranged rotatably on a bearing and is connected via a metal strip to the cylindrical holding element for the mirror. A radially protruding pin is provided on the periphery of the cylindrical holding element. Also mounted on the bearing for the roller is a further pin that is connected via a spring to the radially protruding pin.

With the metal strip, a force required for pivoting the eyepiece is adjustable. Depending on the extent to which the eyepiece is pivoted, the spring tensioned between the two pins exerts a corresponding return force or assists the return motion of the eyepiece.

Mounted on the tube housing is a lateral outlet that is equipped with a port for an additional device. A camera or an evaluation device for light coupled out of the microscope beam path, for example, can be arranged on the port. Provided in the ergotube between the installation element and the mirror is a slider with which multiple optical elements are positionable in the tube beam path or microscope beam path. The optical elements are embodied as plane or spherical optical elements. The slider is moved via a push-pull rod, the push-pull rod being actuable from outside the lateral outlet.

Further advantageous embodiments of the invention may be inferred from the dependent claims.

### BRIEF DESCRIPTION OF THE DRAWINGS

The subject matter of the invention is depicted schematically in the drawings and will be described below with reference to the Figures, in which:

FIG. 1 is a perspective view of an inverted microscope in which the subject matter of the invention is implemented;

FIG. 2 is a perspective depiction of the ergotube, in which the housing parts have been removed to allow a view of the internal configuration of the ergotube; and

FIG. 3 is a sectioned view through the ergotube, to elucidate the internal configuration of the ergotube.

FIG. 4 schematically depicts the beam path of an inverted microscope and the optical elements arranged or to be arranged in the beam path of the inverted microscope;

### DETAILED DESCRIPTION OF THE INVENTION

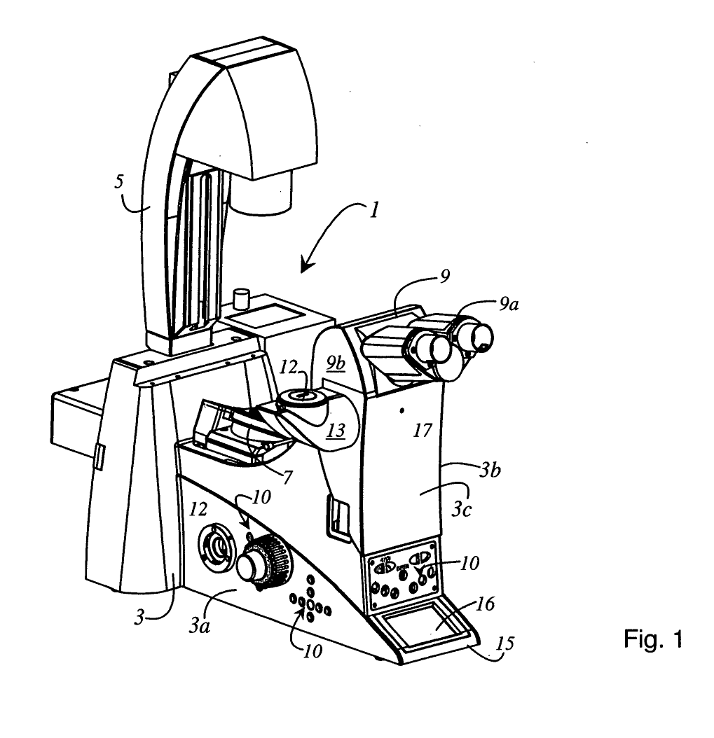

FIG. 1 is a perspective view of an inverted microscope 1 in which the subject matter of the invention is implemented. Inverted microscope 1 comprises a base stand part 3 and an illumination stand part 5 placed on base stand part 3. Base stand part 3 encompasses a first side surface 3a, a second side surface 3b, and a front surface 3c. Base stand part 3 likewise carries an ergotube 9 opposite illumination stand part 5. Ergotube 9 comprises an eyepiece 9a and a tube housing 9b. In this embodiment, eyepiece 9a is embodied as a binocular eyepiece. Mounted on tube housing 9b is a lateral outlet 13 that is equipped with a port 12. The user can connect, for example, a camera, an evaluation device, etc. to port 12. Between illumination stand part 5 and tube 9, base stand part 3 carries a revolving nosepiece 7 with which at least one objective (not depicted) can be introduced into the microscope beam path. In addition to port 12 provided on lateral outlet 13, further ports 12 are embodied on base stand part 3. Multiple actuation knobs 10 are also arranged on first side surface 3a, second side surface 3b, and front surface 3c. Using operating knobs 10, the user can control motorized microscope functions and thus modify, in motorized fashion, corresponding optical components in the interior of base stand part 3 and illumination stand part 5. Base stand part 3 is additionally equipped with a wedge-shaped extension 15 in which a display 16 is incorporated. Display 16 is inclined at an angle of <45° with respect to the horizontal. In addition, display 16 is arranged in such a way that a user taking his or her eyes away from eyepiece 9a can read the information presented on display 16 without modifying his or her working position at the microscope.

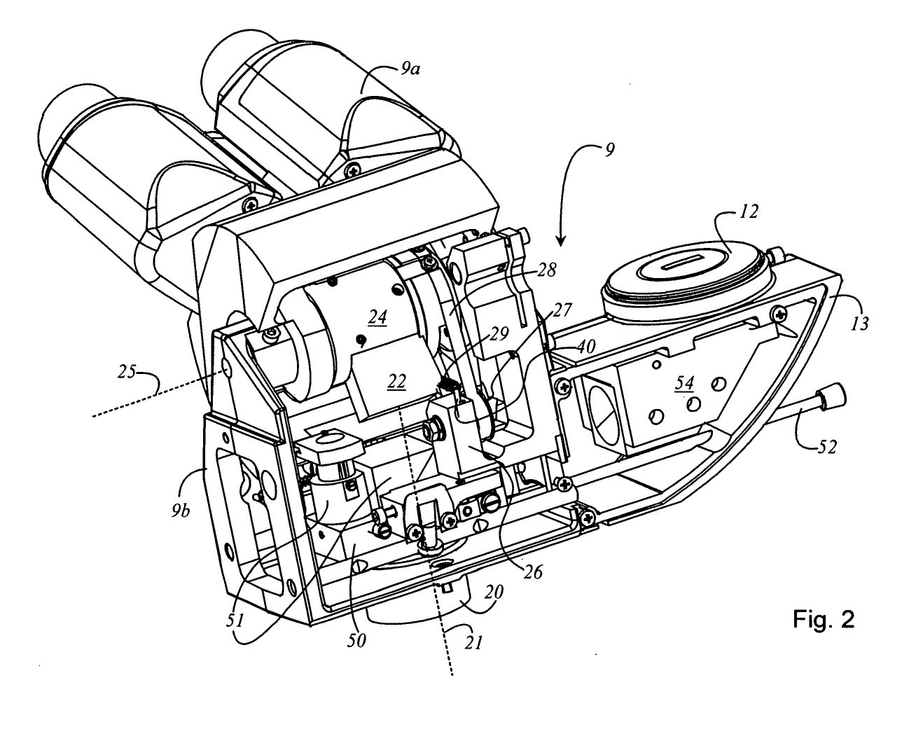

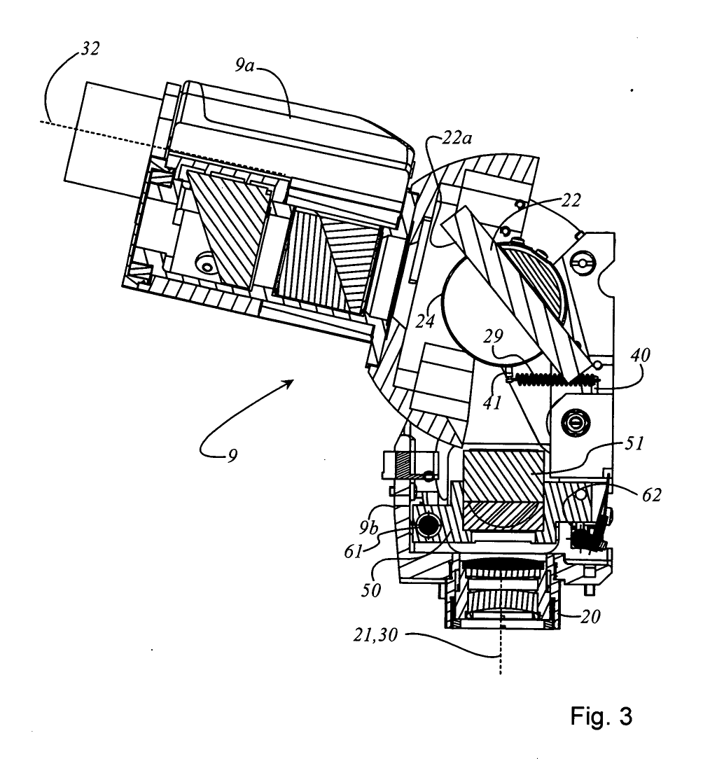

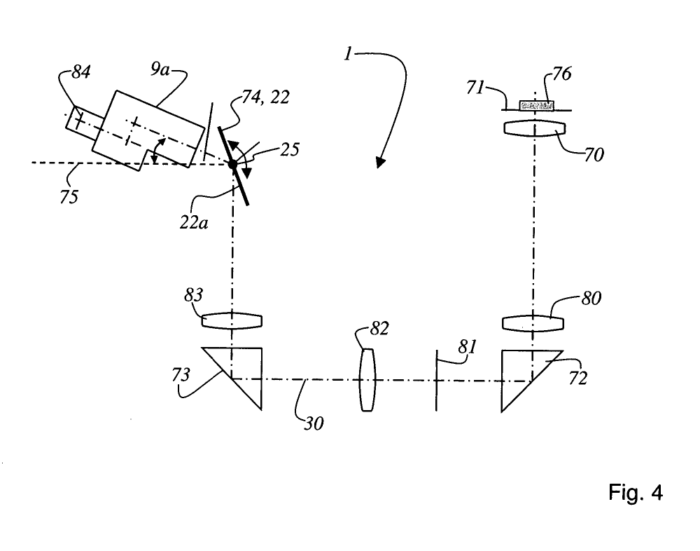

FIG. 2 is a perspective view of ergotube 9 in which housing parts have been removed in order to provide an overview of the internal construction of ergotube 9. As already mentioned, ergotube 9 encompasses an eyepiece 9a that is mounted on a tube housing 9b. Ergotube 9 is equipped with an installation element 20 with which the entire ergotube 9 can be mounted on the microscope stand or on base stand part 3 of the microscope. Tube housing 9b defines a tube beam path 21. Tube beam path 21 is, in principle, the continuation of microscope beam path 30 (see FIG. 4). It should be noted that the terms “tube beam path” and “microscope beam path” are to be used hereinafter in equivalent fashion. Arranged in tube beam path 21 is a mirror 22 that has a mirror surface 22a (see FIG. 3). Eyepiece 9a is mounted pivotably on tube housing 9b. Eyepiece 9a pivots about an axis 25. A cylindrical holding element 24 for mirror 22 is provided on axis 25. Mirror 22 is the only deflection element that deflects tube beam path 21 or microscope beam path 30 into eyepiece beam path 32. Mirror 22 is furthermore installed in holding element 24 in such a way that axis 25 extends centeredly on mirror surface 22a. Embodied in the interior of tube housing 9b is a bearing 26 on which a roller 27 is rotatably supported. Roller 27 is connected via a metal strip 28 to holding element 24. Also attached to bearing 26 is a pin 40 that is connected via a spring 29 to a radially protruding pin 41 on holding element 24. Mounted on tube housing 9b is a lateral outlet 13 that is equipped with a port 12. Port 12 serves for attachment of a camera or another device for evaluating the outcoupled light. Provided between installation element 20 and mirror 22 is a slider 50 with which multiple optical elements 51 are positionable in tube beam path 21. Optical elements 51 can be embodied as plane and/or spherical optical elements. Slider 50 is movable by means of a push-pull rod 52. Push-pull rod 52 can be actuated from outside lateral outlet 13. Also placed in lateral outlet 13 is an optical deflection element 54 with which the outcoupled light beam is deflectable to port 12.

FIG. 3 shows a cross section through ergotube 9 according to the present invention. As already mentioned, ergotube 9 comprises a tube housing 9b on which a pivotable eyepiece 9a is installed. Slider 50 is provided between installation element 20 and mirror 22. Slider 50 carries multiple optical elements 51 that couple tube beam path 21 or microscope beam path 30 out before it strikes deflection mirror 22. Slider 50 is supported in almost frictionless fashion on a first shaft 61 and a second shaft 62.

FIG. 4 schematically shows the configuration of an inverted microscope 1. A fixed stage 71 is arranged above at least one objective 70. A first deflection element 72 and a second deflection element 73 are provided in microscope beam path 30. First deflection element 72 and second deflection element 73 each deflect microscope beam path 30 through 90°. After second deflection element 73, a single third deflection element 74 is provided that deflects microscope beam path 30 into eyepiece 9a. Third deflection element 74 is embodied as a pivotable mirror 22. Eyepiece 9a of ergotube 9 is pivotable about axis 25, which sits in the center of mirror surface 22a defined by pivotable mirror 22. Eyepiece 9a is pivotable in an angular range of 10° to 40° with respect to a horizontal 75. The optical elements in microscope beam path 30 can also be provided on motorization modules, so that they are moved into microscope beam path 30 in accordance with the actuation of operating knobs 10 that are arranged on first side surface 3a, second side surface 3b, or front surface 3c. Because microscope beam path 30 of inverted microscope 1 is U-shaped, the use of motorization modules is unproblematic. An image of specimen 76, which is located at the focus of objective 70, is produced by focusable objective 70 and a first lens system 80 that has a focal point behind first deflection element 72. First image 81 is imaged, via a second lens system 82 that is provided in front of second deflection element 73, and a third lens system 83 (arranged after second lens system 73) and deflection element 74 or deflection mirror 22, into eyepiece 9a. There the user can view a second image 84 that is created by imaging first image 81.

The invention has been described with reference to a particular embodiment. It is self-evident, however, that changes and modifications can be made without thereby leaving the range of protection of the claims below.

What is claimed is:

1. An ergotube comprises: an eyepiece that defines an eyepiece beam path, a tube housing that defines a tube beam path, a mirror having a mirror surface that deflects the tube beam path into the eyepiece beam path, an axis about which the eyepiece embodied pivotably; wherein the axis extends centeredly on the mirror surface and wherein upon pivoting of the eyepiece through an angle α, the mirror is pivoted about an angle α/2, and the mirror is the only deflection element in the tube housing.

2. The ergotube as defined in claim 1, wherein the eyepiece is pivotable with respect to the horizontal in an angular range of 10° to 40°.

3. The ergotube as defined in claim 1, wherein a cylindrical holding element for the mirror is provided on the axis; and the mirror is installed in the holding element in such a way that the axis extends centeredly on the mirror surface.

4. The ergotube as defined in claim 3, wherein in the interior of the tube housing, a roller is arranged rotatably on a bearing and is connected via a metal strip to the cylindrical holding element.

5. The ergotube as defined in claim 4, wherein a radially protruding pin is mounted on the periphery of the cylindrical holding element; a further pin is mounted on the bearing; and the radially protruding pin and the further pin are connected to a spring.

6. The ergotube as defined in claim 4, wherein with the metal strip, a force required for pivoting the eyepiece is adjustable; and the spring exerts a return force that depends on the pivoting.

7. The ergotube as defined in claim 1, wherein a lateral outlet that is equipped with a port for an additional device is mounted on the tube housing.

8. The ergotube as defined in claim 1, wherein a slider, with which multiple optical elements are positionable in the tube beam path, is provided in the ergotube between the installation element and the mirror.

9. The ergotube as defined in claim 8, wherein the optical elements are embodied as plane or spherical optical elements.

10. The ergotube as defined in claim 9, wherein the slider is movable via a push-pull rod; and the push-pull rod is actuable from outside the lateral outlet.

11. An inverted microscope having an ergotube made up of an eyepiece and a tube housing, having at least one objective, having a first deflection element and a second deflection element that are both arranged along a U-shaped microscope beam path, and having a single third deflection element that deflects the microscope beam path into the eyepiece, wherein the third deflection element is embodied as a mirror pivotable about an axis and the eyepiece of the ergotube is deflectable about the axis; and the axis sits in the center of the mirror surface defined by the pivotable mirror.

12. The inverted microscope as defined in claim 11, wherein the eyepiece is pivotal with respect to the horizontal in an angular range of 10° to 40°.

13. The inverted microscope as defined in claim 11, wherein upon a pivoting of the eyepiece through an angle α, the mirror is pivotable through an angle α/2.

14. The inverted microscope as defined in claim 11, wherein incoupling of the microscope beam path into the eyepiece is accomplished according to the Siedentopf principle.

15. The inverted microscope as defined in claim 11, wherein a cylindrical holding element is provided for the mirror on the axis; and the mirror is installed in the holding element in such a way that the axis extends centeredly on the mirror surface.

16. The inverted microscope as defined in claim 11, wherein a lateral outlet that is equipped with a port for an additional device is mounted on the tube housing.
